(19) United States
(12) Patent Application Publication
(10) Pub. No.: US 2019/0359043 A1
(43) Pub. Date: Nov. 28, 2019

(54) SEALING MATERIAL ATTACHMENT METHOD

(71) Applicant: GM GLOBAL TECHNOLOGY OPERATIONS LLC, Detroit, MI (US)

(72) Inventors: Ashish M. Gollapalli, Sterling Heights (US); Wendell G. Summerville, Ferndale (US)

(21) Appl. No.: 15/988,245

(22) Filed: May 24, 2018

(51) Int. Cl. B60J 10/00; B62D 65/06; B62D 25/24; B60J 10/27

(52) U.S. Cl. CPC B60J 10/45; B60J 10/27; B62D 25/24; B62D 65/06

(57) ABSTRACT

A method of attaching a sealing material to a vehicle body includes disposing a sealing material retaining part on the vehicle body. The retaining part includes a top surface configured to form a fluid seal with a compressed sealing material when a vehicle panel is in a closed position. An insertion channel extends between opposing ends of the retaining part and is configured to allow the sealing material to be slidably inserted therein. A bottom surface of the retaining part includes a retaining feature disposed proximate an end opposite of an end of the retaining part configured to allow the sealing material to be slidably inserted. A sealing material is provided that includes at least one perforated opening for receiving the retaining feature when the sealing material is slidably inserted into the insertion channel.

### TECHNICAL FIELD

The present disclosure relates to sealing methods and more particularly to a method for attaching a sealing material to an article of manufacture.

### BACKGROUND

Seals and seal assemblies are used extensively in various industries for, among other purposes, preventing fluids and foreign objects from passing through joints or cracks between mating surfaces. Seals are used around doors, door frames, hoods, trunks, lids, and windowpanes in particular and are attached to mounting flanges or through use of adhesive materials. It is known to mount seals around the perimeter of an opening of an article (e.g., vehicle, appliance, door, etc.) with screws or by using a plurality of clips spaced along the length of the sealing material. A shortcoming of these methods is the requirement of numerous fasteners can be costly and labor intensive and difficult to install.

It is desirable, therefore, to provide a seal assembly that requires reduced installation effort while also maximizing the force required to remove it from its mounting location. It is also desirable to provide seal retention system to increase manufacturing efficiency and to reduce the number of parts required for assembly of an article of manufacture.

### SUMMARY

One or more exemplary embodiments described herein provide a method for attaching sealing weather stripping to an article of manufacture.

In accordance with one embodiment, a method for attaching sealing material to an article of manufacture includes disposing a seal retaining part on the article of manufacture wherein the retaining part includes a top surface configured to form a fluid seal with a compressed sealing material when an open body panel is in a closed position, an insertion channel extending longitudinally between opposing ends of the retaining part wherein at least one opposing end is configured to allow the sealing material to be slidably received into the insertion channel, and a bottom surface having at least one retaining feature disposed proximate an end opposite of the at least one opposing end of the retaining part configured to allow the sealing material to be slidably received into the insertion channel. Another aspect includes providing a sealing material that includes a base portion having at least one perforated opening configured to receive the at least one retaining feature when the sealing material is slidably received into the insertion channel of the retaining part. And still another aspect includes slidably inserting the sealing material into the insertion channel until the at least one retaining feature is received into the at least one perforated opening.

Yet a further aspect according to an exemplary embodiment wherein the retaining part includes a plurality of retaining features disposed on the bottom surface between the opposing ends. And another aspect wherein the at least one retaining feature includes at least one ramped side directed toward the at least one opposing end configured to allow the sealing material to be slidably received into the insertion channel. And a further aspect includes providing at least one rigidity bridge on the retaining part configured to allow the sealing material to slidably pass through after being received into the insertion channel. And still further aspects are provided wherein the retaining part is formed integral to the article of manufacture, or wherein the retaining part is selectively disposed on the article of manufacture.

Still another aspect includes slidably removing the sealing material from the retaining part through an end of the retaining part that is opposite the at least one opposing end of the retaining part configured to allow the sealing material to be slidably received into the insertion channel. And one other aspect includes replacing the removed sealing material by slidably inserting a replacement sealing material into the insertion channel until the at least one retaining feature is received into the at least one perforated opening. And still other aspects wherein the body panel is a hood, or wherein the body panel is a door.

The detailed description and the drawings or Figures are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is an illustration of a partial vehicle body wherein a sealing material attachment method in accordance with aspects of an exemplary embodiment may be employed.

FIG. 2A is an illustration of a top view of a retaining part used in the sealing material attachment method in accordance with aspects of an exemplary embodiment.

FIG. 2B is an illustration of a bottom view of a retaining part used in the sealing material attachment method in accordance with aspects of an exemplary embodiment.

FIG. 3 is an illustration of a retaining part being formed integrally to a vehicle body in accordance with aspects of an exemplary embodiment.

FIG. 4A is an illustration of a retaining part and sealing material assembly in accordance with aspects of an exemplary embodiment.

FIG. 4B is an illustration of a perspective view the retaining part and sealing material assembly of FIG. 4A in accordance with aspects of an exemplary embodiment.

FIG. 5A is an illustration of a retaining part featuring a rigidity bridge in accordance with aspects of an exemplary embodiment.

FIG. 5B is an illustration of an enlarged view of the rigidity bridge of FIG. 5A with the sealing material inserted in accordance with aspects of an exemplary embodiment.

FIG. 6 is an illustration of an algorithm for the method of attaching sealing material weather stripping to a vehicle body in accordance with aspects of an exemplary embodiment.

### DETAILED DESCRIPTION

Those having ordinary skill in the art will recognize that all directional references (e.g., above, below, upward, up, downward, down, top, bottom, left, right, vertical, horizontal, etc.) are used descriptively for the figures to aid the reader's understanding, and do not represent limitations (for example, to the position, orientation, or use, etc.) on the scope of the disclosure, as defined by the appended claims.

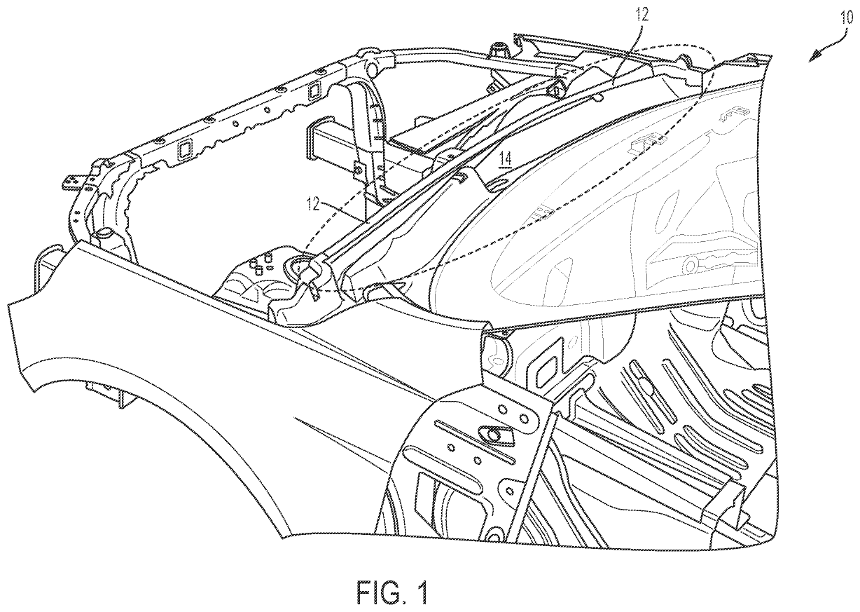

Referring to the Figures, wherein like numerals indicate like or corresponding parts throughout the several views, a method of attaching sealing material to a vehicle body is generally shown in FIGS. 1-6.

Referring to FIG. 1, an illustration of a partial vehicle body 10 wherein a sealing material attachment method in accordance with aspects of an exemplary embodiment may be employed is provided. The partial vehicle body 10 includes a sealing material 12 disposed proximate a cowl 14 portion of the vehicle body 10. The vehicle cowl 14 is the forward part of the body of a vehicle for supporting the rear of the hood and the windshield and for housing portions of the pedals and instrument panel. The sealing material prevents air and fumes from entering the cab of the vehicle. This sealing material typically runs the width of the vehicle across the cowl 14, and most vehicles require special fasteners and clips for securing this part to the vehicle cowl. It should be appreciated that FIG. 1 is merely illustrative of one area of the vehicle body where sealing materials and the method for sealing material attachment in accordance with aspects of the exemplary embodiment may be utilized. Sealing materials and the disclosed method may also employed in other areas of the vehicle body wherein body panels that are subject to frequent opening and closing (e.g., doors, hoods, trunks, windows sunroofs) and wherein sealing is needed to prevent intrusion of contaminates (e.g., water, air, dust, noise, fumes) into the interior cab of the vehicle when the body panels are in the closed position. Further, the disclosed method for attaching sealing material to an article of manufacture may be used in other industries (e.g., home appliance, maritime, construction, etc.) without exceeding the scope of this disclosure.

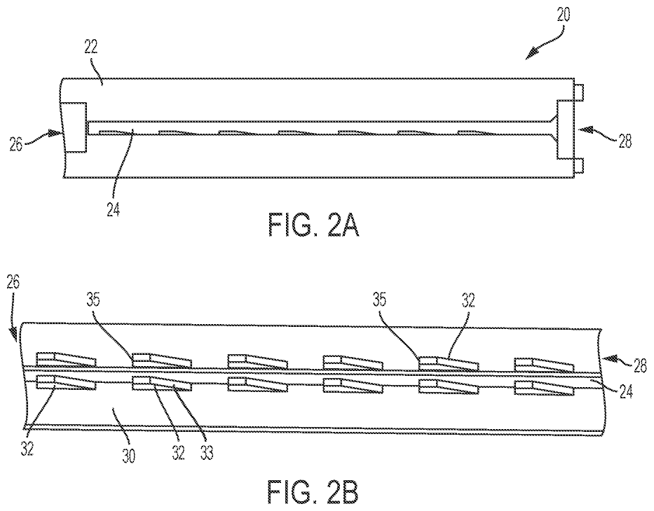

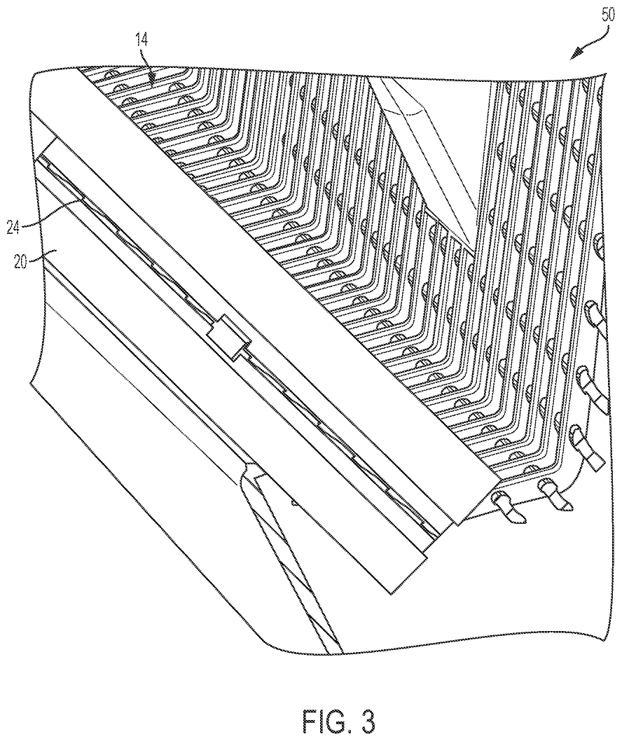

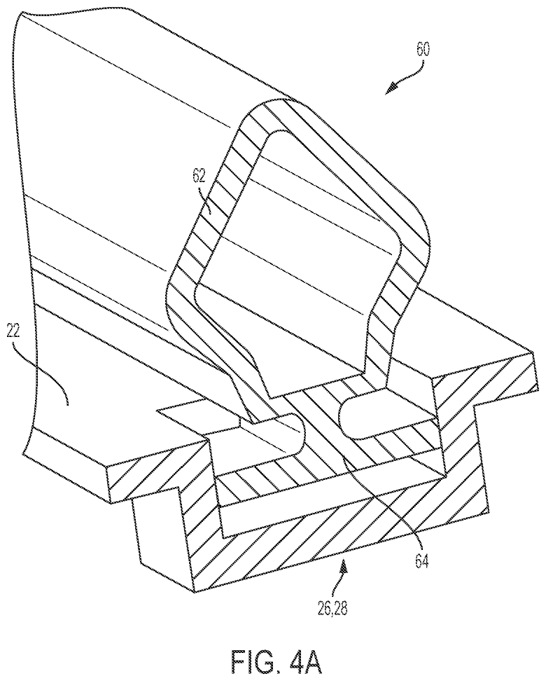

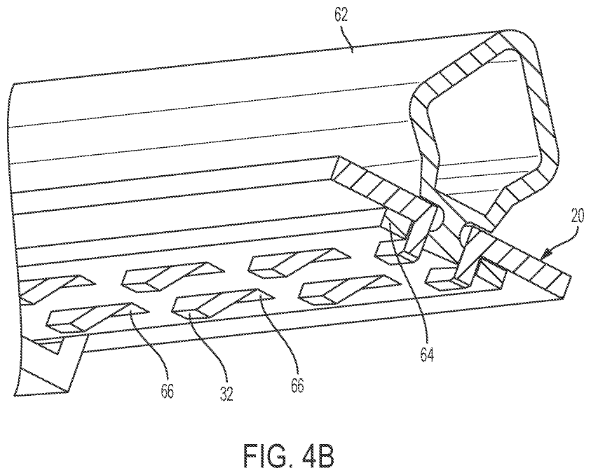

Referring now to FIGS. 2A and 2B, illustrations of top and bottom views of a retaining part 20 for use in the sealing material attachment method in accordance with aspects of an exemplary embodiment are provided. FIG. 2A illustrates a top view of the retaining part 20 having a smooth top surface 22 configured to form a fluid seal with a compressed sealing material when a vehicle body panel is in a closed position. The retaining part 20 includes an insertion channel 24 that extends longitudinally between opposing ends (26, 28) of the retaining part 20 wherein at least one opposing end (26, 28) is configured to allow the sealing material 60 to be slidably received into the insertion channel 24 (See FIG. 4A). FIG. 2B illustrates a bottom view of the retaining part 20 with a bottom surface 30 having at least one retaining feature 32 disposed proximate an end 26 opposite of the at least one opposing end 28 of the retaining part 20 configured to allow the sealing material 60 to be slidably received into the insertion channel 24. The at least one retaining feature 32 includes at least one ramped side 33 directed toward the at least one opposing end 28 configured to allow the sealing material to be slidably received into the insertion channel 24. The at least one retaining feature 32 also includes a substantially perpendicular edge 35 that descends from the crest of the ramped side 33. The substantially perpendicular edge 35 operates as a locking or fixing edge of the retaining feature 32 such that when the sealing material 60 is slidably received in the retaining channel 24 it cannot be pulled out of the insertion channel 24 in the backwards direction toward the insertion end 28 of the retaining part 20.

Referring now to FIG. 3, an illustration 50 is provided of a retaining part 20 being formed integrally to a vehicle body in accordance with aspects of an exemplary embodiment. For example, the retaining part 20 may be integrally formed into the vehicle cowl 14 or other areas of the vehicle body and/or body panels where sealing is required such as doors, trunks, and deck lids.

FIG. 4A is an illustration of a retaining part 20 and sealing material 60 assembly in accordance with aspects of an exemplary embodiment wherein at least one of the opposing ends (26, 28) is configured to slidably receive a sealing material into the insertion channel 24 of the retaining part 20. The sealing material 60 includes a compressible top portion 62 that forms a fluid seal with the top surface 22 of the retaining part 20 when a vehicle body panel is closed. The sealing material 60 also includes a base portion 64 that is formed to be received into the insertion channel 24 such that the retaining part 20 collars the sealing material 60 between the compressible top portion 62 and the base portion 64. This collar feature operates to restrain upward or downward movement of the sealing material 60 when inserted in the retaining part 20.

FIG. 4B is an illustration of a perspective view the retaining part 20 and sealing material 60 assembly of FIG. 4A wherein the base portion 64 of the sealing material 60 includes at least one perforated opening 66 configured to receive the at least one retaining feature 32 when the sealing material 60 is slidably received into the insertion channel 24 of the retaining part 20. It is appreciated that the perforations 66 of the base portion 64 and the retaining features 32 of the retaining part cooperate in a fastening manner such that the sealing material 60 does not require additional clips or fasteners to be held in place as opposed to conventional sealing material attachment methods.

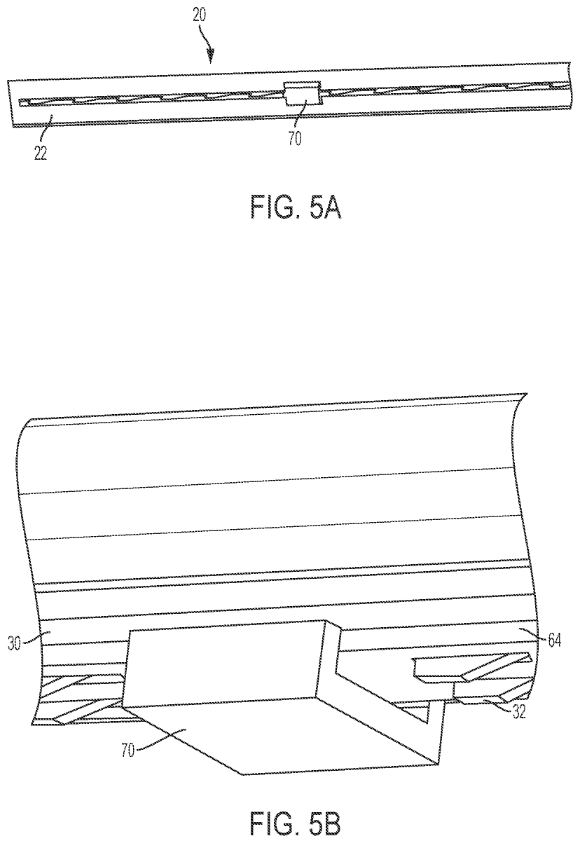

Referring now to FIGS. 5A and 5B, illustrations of a retaining part 20 having at least one rigidity bridge 70 on the retaining part 20 configured to allow the sealing material to slidably pass through after being received into the insertion channel 24 and to provide rigid stability to the retaining part 20 when the sealing material 60 is being received into the insertion channel 24. As best illustrated in FIG. 5B, the rigidity bridge 70 extends from the bottom surface 30 of the retaining part 20. In one embodiment, the rigidity bridge 70 is disposed proximate mid-length of the retaining part 20. In another embodiment, a plurality of rigidity bridges are disposed along the length of the retaining part 20 to provide rigid stability to the retaining part 20 as much as necessary.

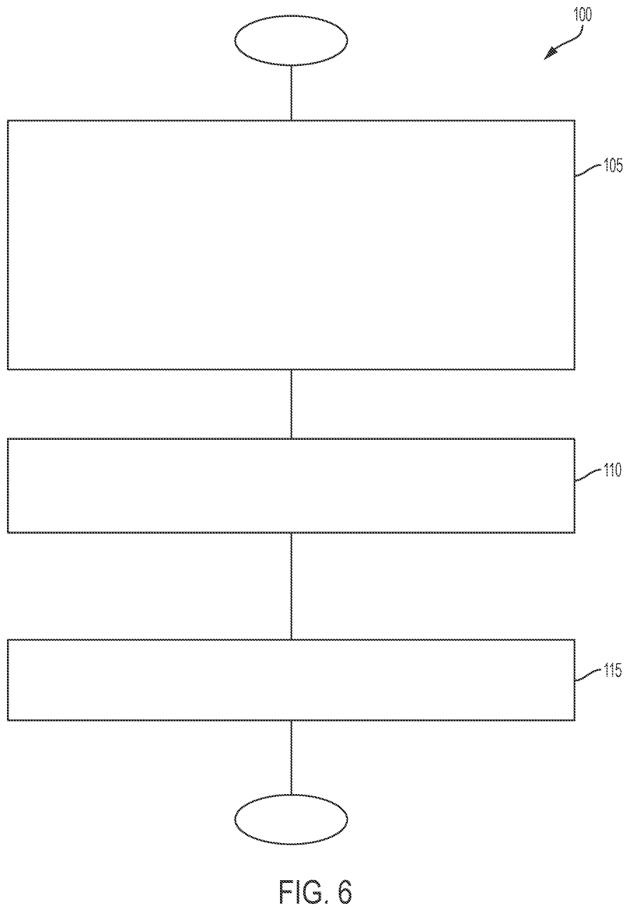

Referring now to FIG. 6 an illustration of an algorithm 100 for the method of attaching sealing material to a vehicle body in accordance with aspects of an exemplary embodiment is provided. At block 105, the method begins with disposing a sealing material retaining part on the vehicle body wherein the retaining part includes a top surface configured to form a fluid seal with a compressed sealing material when a vehicle body panel is in a closed position, an insertion channel extending longitudinally between opposing ends of the retaining part wherein at least one opposing end is configured to allow the sealing material to be slidably received into the insertion channel, and a bottom surface having at least one retaining feature disposed proximate an end opposite of the at least one opposing end of the retaining part configured to allow the sealing material to be slidably received into the insertion channel. Next, at block 110, the method continues with providing a sealing material that includes a base portion having at least one perforated opening configured to receive the at least one retaining feature when the sealing material is slidably received into the insertion channel of the retaining part. Then, at block 115, the method continues with slidably inserting the sealing material into the insertion channel until the at least one retaining feature is received into the at least one perforated opening.

Further, the method may be extended for replacement of a damaged sealing material by slidably removing the sealing material from the retaining part through an end of the retaining part that is opposite the at least one opposing end of the retaining part configured to allow the sealing material to be slidably received into the insertion channel. Thereafter, the method continues with replacing the removed sealing material by slidably inserting a replacement sealing material into the insertion channel until the at least one retaining feature is received into the at least one perforated opening in the base portion of the sealing material.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of attaching a sealing material to an article of manufacture comprising:
disposing a sealing material retaining part on the article of manufacture wherein the retaining part includes a top surface configured to form a fluid seal with a compressed sealing material when an open body panel is in a closed position, an insertion channel extending longitudinally between opposing ends of the retaining part wherein at least one opposing end is configured to allow the sealing material to be slidably received into the insertion channel, and a bottom surface having at least one retaining feature disposed proximate an end opposite of the at least one opposing end of the retaining part configured to allow the sealing material to be slidably received into the insertion channel;
providing a sealing material that includes a base portion having at least one perforated opening configured to receive the at least one retaining feature when the sealing material is slidably received into the insertion channel of the retaining part; and
slidably inserting the sealing material into the insertion channel until the at least one retaining feature is received into the at least one perforated opening.

2. The method of claim 1 wherein the at least one retaining feature includes at least one ramped side directed toward the at least one opposing end configured to allow the sealing material to be slidably received into the insertion channel.

3. The method of claim 1 wherein the retaining part includes a plurality of retaining features disposed on the bottom surface between the opposing ends.

4. The method of claim 3 wherein the plurality of retaining features includes at least one ramped side directed toward the at least one opposing end configured to allow the sealing material to be slidably received into the insertion channel.

5. The method of claim 1 further comprising providing at least one rigidity bridge on the retaining part configured to allow the sealing material to slidably pass through after being received into the insertion channel.

6. The method of claim 1 wherein the retaining part is formed integral to the article of manufacture.

7. The method of claim 6 wherein the article of manufacture is a vehicle body.

8. The method of claim 1 wherein the body panel is a vehicle hood.

9. The method of claim 1 wherein the body panel is a vehicle door.

10. The method of claim 1 further comprising slidably removing the sealing material from the retaining part through an end of the retaining part that is opposite the at least one opposing end of the retaining part configured to allow the sealing material to be slidably received into the insertion channel.

11. The method of claim 10 further comprising replacing the removed sealing material by slidably inserting a replacement sealing material into the insertion channel until the at least one retaining feature is received into the at least one perforated opening.

12. A method of attaching a sealing material to a vehicle body comprising:
disposing a sealing material retaining part on the vehicle body wherein the retaining part includes a top surface configured to form a fluid seal with a compressed sealing material when a vehicle panel is in a closed position, an insertion channel extending longitudinally between opposing ends of the retaining part wherein at least one opposing end is configured to allow the sealing material to be slidably received into the insertion channel, and a bottom surface having at least one retaining feature disposed proximate an end opposite of the at least one opposing end of the retaining part configured to allow the sealing material to be slidably received into the insertion channel, wherein the at least one retaining feature includes at least one ramped side directed toward the at least one opposing end configured to allow the sealing material to be slidably received into the insertion channel;
providing a sealing material that includes a base portion having at least one perforated opening configured to receive the at least one retaining feature when the sealing material is slidably received into the insertion channel of the retaining part; and
slidably inserting the sealing material into the insertion channel until the at least one retaining feature is received into the at least one perforated opening.

13. The method of claim 12 wherein the retaining part includes a plurality of retaining features disposed on the bottom surface between the opposing ends.

14. The method of claim 12 further comprising further comprising providing at least one rigidity bridge on the retaining part configured to allow the sealing material to slidably pass through after being received into the insertion channel.

15. The method of claim 12 wherein the retaining part is formed integral to the vehicle body.

16. The method of claim 12 further comprising slidably removing the sealing material from the retaining part through an end of the retaining part that is opposite the at least one opposing end of the retaining part configured to allow the sealing material to be slidably received into the insertion channel.

17. The method of claim 16 further comprising replacing the removed sealing material by slidably inserting a replacement sealing material into the insertion channel until the at least one retaining feature is received into the at least one perforated opening.
